(19) United States
(12) Patent Application Publication
(10) Pub. No.: US 2004/0168709 A1
(43) Pub. Date: Sep. 2, 2004

(54) Process control, monitoring and end point detection for semiconductor wafers processed with supercritical fluids

(76) Inventors: James M. Drumm, Garland, TX (US); Brian K. Kirkpatrick, Allen, TX (US)

Correspondence Address: TEXAS INSTRUMENTS INCORPORATED, P O BOX 655474, M/S 3999, DALLAS, TX, 75265

(21) Appl. No.: 10/375,586

(22) Filed: Feb. 27, 2003

(51) Int. Cl. B08B 7/04

(52) U.S. Cl. 134/18

(57) ABSTRACT

The nature of the fluid in or leaving the CO₂ cleaning chamber is monitored by UV or IR spectrophotometry, by laser particle counting, by electrical or thermal conductivity, or other physical or mechanical properties. These properties are used to determine if or when the process is completed or to verify that the process is within normal process operation range.

### FIELD OF INVENTION

This invention relates to process control, monitoring and end point detection of parts cleaned and more particularly to detection of semiconductor wafers cleaned with supercritical fluids.

### BACKGROUND OF INVENTION

Supercritical Fluid cleaning is poised to replace conventional solvent or acid cleaning and photoresist stripping in applications where via depth or underlying material sensitivity make conventional processing difficult and require new processes and equipment. Other advantages associated with using supercritical fluids for wafer cleaning include benign process temperatures, an all-dry process, environmental friendliness of the process as compared to conventional processes, and cost savings associated with lower chemical and deionized water consumption and smaller space.

The most common example of a supercritical fluid is CO₂. FIG. 1 shows where the supercritical region exists. It is in a region above 1000 PSI and a temperature above about 70 degrees F. A conventional process step in the manufacturing of semiconductor device is the removal of photoresist from a semiconductor wafer after it has been patterned and the material underneath it has been etched to create submicron sized holes and trenches. The photoresist and the etching reaction products are removed in a plasma asher and subsequently wet cleaned in acids or solvents to remove the remaining salts, polymers, and post ash residues. However. the wet cleaning step is potentially detrimental to the material being etched especially if it is a porous dielectric material consisting of holes or pores that can absorb the cleaning fluid. In many instances the wet cleaning process will degrade the insulating properties of the film by lowering the dielectric constant K of the material or by altering the physical dimension of the holes or trenches previously formed by the etching step.

The interconnect part of the semiconductor wafer is made up of multiple layers of copper plated into vias and trenches surrounded by dielectric materials. Removing the bulk photoresist after patterning and etching the vias and trenches with plasma ashing and/or wet cleaning will potentially result in damage to the new lower K dielectric film's properties. The lower K dielectric materials are porous and like a sponge they can absorb fluids and gases and make it difficult to get the cleaning chemicals out of the pores. Since supercritical fluids have some of the chemical cleaning and solubility advantages of liquids but have the evaporation and penetration ability of gases, they can be used to clean and remove post etch and post ash residue without absorbing into the dielectric film and decreasing its K value as liquids will do. Since plasma ashing is usually performed above room temperature and often as high as 400 degrees C., plasma ashing can significantly affect the thermal process budget in a typical advanced process with 6-9 layers of interconnect and up to 16 ion implant steps. Some supercritical fluids can strip resist and clean wafers below 100 degrees C. For copper especially, the user wants to work at lower temperatures since higher temperatures have a detrimental affect on the copper metallization and can decrease the life of the semiconductor device. In the conventional wet or solvent cleaning it is typical for the insulating property or k-value of a porous low-k dielectric to decrease which has an undesirable affect on the electrical parametrics of the semiconductor device. However cleaning using supercritical fluids has been shown to increase the k-value and thus improve the performance of the semiconductor device.

The process functions at benign temperatures and is dry instead of wet. Wet is always undesirable because you have to go through a dry step. When cleaning with supercritical fluids a co-solvent is used. The supercritical fluid acts as a carrier and the co-solvent such as methanol or ethanol actually does the cleaning, dissolving the salts, etc.

It is highly desirable to determine when the cleaning process or step is complete or to verify that the process is within normal operation range.

A spectrophotometric supercritical fluid contamination monitor as described in U.S. Pat. No. 5,777,726 of Krone-Schmidt may be used. This is a system for detecting the presence of contaminant in a flowing stream of supercritical fluid. A sample stream is removed from a flowing stream of supercritical fluid and is subjected to reduced pressure in a contaminant measurement zone such as after the valve 18 in FIG. 2. The supercritical fluid turns into gas at the reduced pressure with the contaminants remaining in a non-gaseous form. An attenuated total reflectance plate is used to spectrophotometrically detect the presence of the non-gaseous contaminants, which deposit on the surface of the plate within the contaminant measurement zone. This method requires the gas go into a secondary chamber and that material deposits on a detector.

It is desirable to provide an improved process for determining end point cleaning so that the cleaning process time can be minimized and the throughput on the machine increased.

### SUMMARY OF INVENTION

In accordance with one embodiment of the present invention, a detection device, which measures a property of the surface of semiconductor wafer, is provided to determine when the process is complete or to verify that the process is within a normal process operation range. The machine would then be signaled to proceed with the next process step or to unload the semiconductor wafer and load the next one.

In accordance with an embodiment of the present invention a detection device that measures properties of the gas in the process chamber and determines when the process is complete or to verifies that the process is within a normal process operating range.

In accordance with an embodiment of the present invention a laser based particle detector monitoring the effluent gasses is used to determine when the process is complete or to verify that the process is within a normal process operation range.

In accordance with an embodiment of the present invention the supercritical fluid is monitored by residual gas analyzer.

In accordance with an embodiment of the present invention the supercritical fluid is monitored by laser particle counter.

In accordance with another embodiment of the present invention the supercritical fluid measurement is monitored by electrical or thermal conductivity.

### DESCRIPTION OF DRAWINGS

FIG. 1 is a plot of temperature versus pressure indicating the supercritical region.

FIG. 2 is a schematic drawing of a sample cleaning system as used in the present invention.

FIG. 3 illustrates a system with detection according to one embodiment of the present invention.

FIG. 4 a schematic drawing of a sample cleaning system according to one embodiment of the present invention.

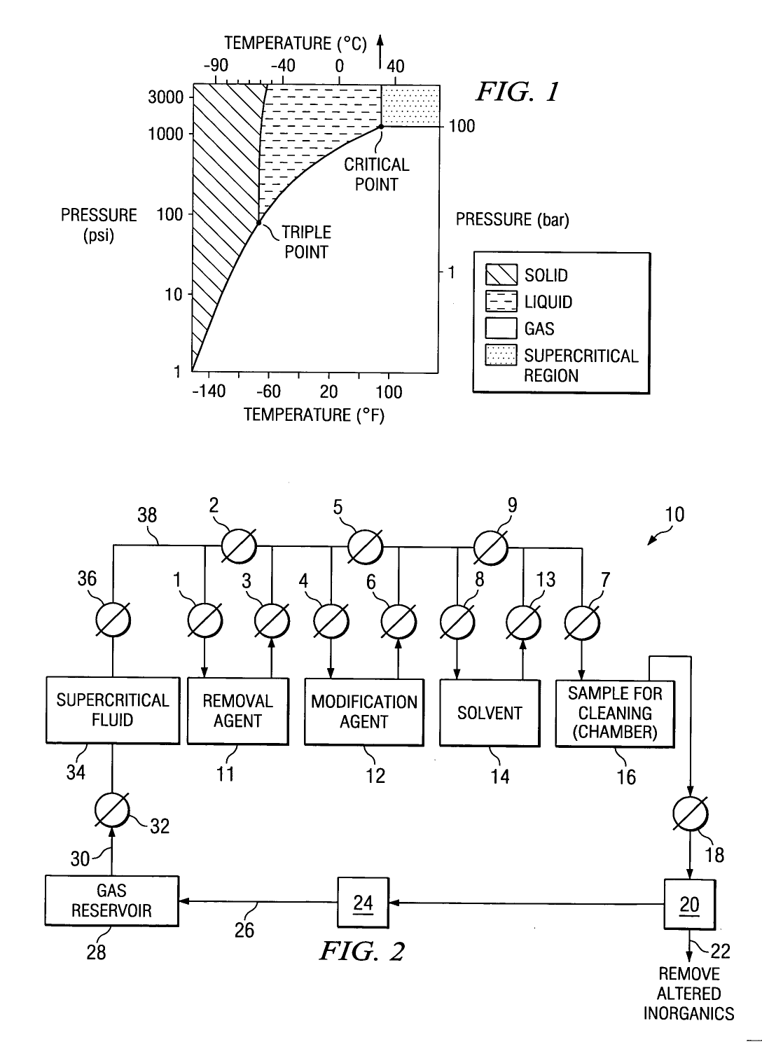

### DESCRIPTION OF PREFERRED EMBODIMENTS OF THE PRESENT INVENTION

As discussed in the background cleaning with supercritical fluids is described, for example, in Texas Instruments Inc. U.S. Pat. No. 5,686,856 of Douglas et al. entitled “Method for Removing Inorganic Contamination by Chemical Derivitization and Extraction.” This is also discussed in Texas Instruments Inc. U.S. Pat. No. 5,868,862 of Douglas et al entitled “Method of Removing Inorganic Contamination by Chemical Alteration and Extraction in a Supercritical fluid Media.” These patents are incorporated herein by reference.

The method describes removing inorganic contamination from a layer overlying a substrate that includes the steps of removing the layer overlying the substrate with at least one removal agent; reacting the inorganic contamination with at least one conversion agent, thereby converting the inorganic contamination; removing the converted inorganic contamination by subjecting it to at least one solvent agent, the solvent agent included in a first supercritical fluid; and wherein the converted inorganic contamination is more highly soluble in the solvent agent than the inorganic contamination. In the specification the second removal agent is comprised of HF and the supercritical fluid is CO₂. The conversion agent may be selected from the group consisting of: an acid agent, a base agent, a chelating agent, a liquid agent, a halogen-containing agent, and any combination thereof.

Referring to FIG. 2 there is illustrated the sample cleaning system as described in U.S. Pat. No. 5,686,862. The sample to be cleaned is held in chamber or container 16. A supercritical fluid is supplied from a gas reservoir 28 which is connected by a conduit 30, which includes a valve 32, to a pressurization unit 34 that increases pressure of the gas to greater than 70 to 75 atmospheres at a temperature greater than about 32 degrees C. to form a supercritical fluid. The supercritical fluid travels through a valve 36 and conduit 38 to a reservoir with valves 1 and 3 open and valve 2 closed that holds a solid, liquid, or gas removal agent(s). The removal agent may be comprised of hydrofluoric acid. It may be introduced either by vapor exposure, plasma exposure, or by exposing the semiconductor wafer to a supercritical fluid (preferably CO₂), which contains HF. The conversion agent may be comprised of HF or any other halogen-containing agent (preferably chlorine). Other possible removal agents are discussed in the patent. The passing of the supercritical fluid through the removal agent acts to incorporate the modification agent into the supercritical fluid. The supercritical fluid incorporated with the removal agent leaves the reservoir 11 and enters the container or chamber 16. The SCF mixture and inorganic contamination are introduced, resulting in the removal of the top layer containing the inorganic contamination, thereby exposing the inorganic contamination.

Subsequent to or simultaneous with the removal of the top layer containing the inorganic contamination by the removal agent and subsequent to or simultaneous with removing the modified inorganic contamination, the SCF travels through valve 36 to reservoir 12 which holds a solid, liquid of gaseous modification agent(s). This is accomplished by closing valves 1,3 and 5 and opening valves 2,4 and 6 in FIG. 2. The passing of the SCF through the modification agent acts to incorporate the modification agent into the SCF. The SCF incorporated with the modification agent leaves the reservoir 12 and enters chamber 16. Possible modification agents are listed in the patent. The conversion agent may be introduced by vapor pressure to the wafer, plasma exposure to the wafer, or by exposing the wafer to a supercritical fluid (preferably CO₂) that includes the conversion agent. Preferably the, the conversion agent is comprised of an acid, a chelating agent, or a halogen agent.

Subsequent to or simultaneous with the removal of the top layer containing the inorganic contamination by the removal agent and subsequent to and simultaneous with the modification of the inorganic contamination on the semiconductor sample by the modification agent, the SCF travels through the valve 36 to reservoir 14 which holds a solid, liquid, or gaseous solvent agent(s). Possible solvent agents are listed in the patent. This is accomplished by closirtg valves 1,3,4,6 and 9 and opening valves 2,5 and 8. The passing of the SCF through the solvent agent acts to incorporate the solvent agent into the SCF. The SCF incorporated with the solvent leaves the reservoir and enters the chamber 16. The SCF mixture and the exposed and modified inorganic contamination are introduced, thereby resulting in the removal of the exposed and modified inorganic contamination from the surface of the wafer. The solvent agent may be comprised of a polar gas, nonpolar gas, polar SCF, nonpolar SCF (preferably CO₂), a polar species (like water, ethanol, methanol, acetone, or glycol), a non polar species, surfactants, detergents, or amphoteric materials, or a chelating agent, which is preferably included in a supercritical fluid. For more details on the list see the references patents.

The modified inorganic contaminant and the CO₂ are removed and passed through depression valve 18 such that the inorganic contaminant precipitates in the container 20. The CO2 gas is then recycled by pump 24 through line 26 to reservoir 28. The inorganic con be remove by line 22.

A semiconductor wafer 15 is placed in the chamber 16 as discussed above for example for cleaning as discussed in connection with U.S. Pat. No. 5,888,856 or 6,868,862. The CO₂, the co-solvent and stripper are applied to the input to the process chamber 16 that has control ranges of 1070-8000 PSI and operates at a temperature of between 32 and 100 degrees C. It is the purpose of one embodiment of the present invention to provide a means to determine when it is cleaned, done or finished.

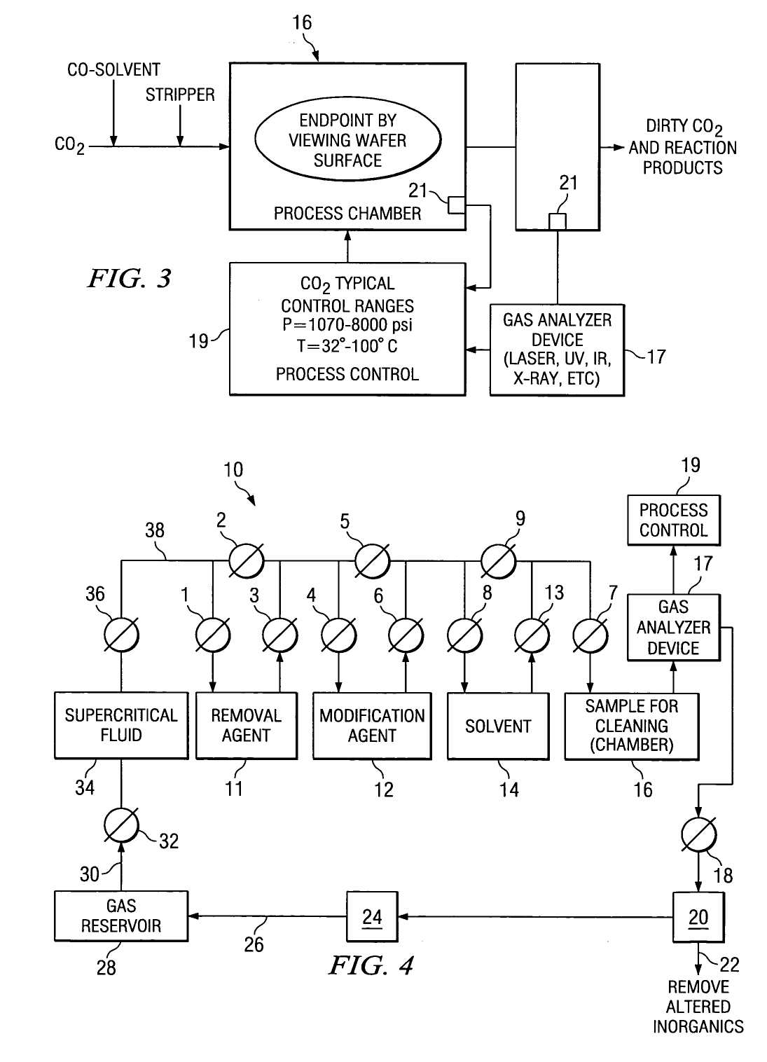

In accordance with one embodiment of the present invention illustrated in FIG. 3, the nature of the fluid in the chamber 16 or effluent exiting the chamber at an analyzer 17 is monitored by a sensor 21 to generate a control signal that is sent to a process control 19 coupled to the chamber 16 to control the process time based on cleanliness of the wafer. The sensor 21 measures properties related to the wafer processing such as the particle level, the amount of co-solvent in the supercritical fluid, the amount of residue in the fluid leaving the chamber, etc. When the sensor 21 detects the cleaning is complete, a control signal is sent to the control 19 for the process to stop the process and proceed to the next process stop or to process the next wafer.

In one embodiment of the present invention a residual gas analyzer is the sensor 21 at the analyzer 17 after the chamber 16 and is used to determine for example the end point of the process. A residual gas analyzer determines what atomic mass units are in the effluent out of the chamber 16. While oxygen has an atomic mass of 16 and O₂ is 32, polymers associated with inorganic contamination have much high common mass units. When the stripping is taking place it does not come off in molecular form but by chunks. After the plasma ashing process one has pretty much removed the photoresist. There is still a residual polymer composed of carbon, hydrogen, oxygen, and silicon. What also exists is some of the low K dielectric as well as the etch gasses. There is also some chlorine. The high common mass units in the effluent drop down toward zero when the polymers are removed. This indicates that the wafer is cleaned. When the sensor 21 at analyzer 17 detects that the wafer is cleaned, the analyzer sends a control signal from the analyzer 17 to the control 19 to stop the cleaning.

In accordance with one embodiment for removing polymers for a one pass the residual gas analyzer 17 looks for the high atomic mass unit species going by in the effluent from the chamber 16. The residual gas analyzer 17 may also look for when a particular peak of the atomic weight spectrum disappears, determine which etch chemistry is in use, and/or which dielectric is being etched. It can also be used to determine a species that has a characteristic atomic mass in it and look for the peak to approach zero.

Another residual gas analyzer embodiment is for stripping polymers in a re-circulation system as illustrated in FIG. 4. The analyzer 17 including the sensor 21 is located after the chamber 16 to receive the effluent from the chamber. The analyzed results are used to send a control signal to the process control 19 to control the process such as when the cleaning is done. The supercritical fluid is an expensive chemical and the system uses large volumes of it (6 liters/wafer). It is therefore desirable that the effluent be kept and recycled. It is therefore re-circulated back into the chamber 16 for other wafers in the single-pass or for continued cleaning of a given wafer in the re-circulated system. In the re-circulation system the residual gas analyzer 17 looks for high molecular weights to decrease or to approach zero. In this case the end point is indicated by the high atomic mass value decreasing in the residual gas analyzer 17. Those using electro solvents and those not using co-solvents look for rate of rise of the species detected approaching zero.

Another embodiment is as a bulk film etcher removing metal and dielectric. For either single-pass or re-circulation systems a residual gas analyzer 17 looks for a characteristic atomic mass unit to quit climbing in the residual gas analyzer 17.

Other means of detection may be used. The sensor 21 in the chamber 16 may use a property of the surface of the wafers using absorbance, reflection or deflection of ultraviolet, infrared, X-ray or visible light on the wafer surface. In this case the system looks at the surface and figures out when it is cleaned or when the process step is complete. A beam hits the wafer 15, and the sensor system 21 determines if the reflection has changed or color of the wafer has changed. If doing bulk photoresist the detection by the sensor 21 may be optical because it is inexpensive and can use the absorbance or reflectance of light from the wafer surface to detect surface changes. Since reflectance of light on the wafer 15 changes it can detect when the photoresist is gone and a signal can be sent to stop the process or to proceed to the next process step after a fixed time.

In accordance with another embodiment of the present invention the sensor 21 is a laser based gas particle detector on the effluent gas at an analyzer 17. This sensor projects light through the gas stream in the effluent and based on how the light is scattered, the size and quantity of particles in the gas stream is measured to determine when the cleaning process is complete.

The sensor 21 may be provided by an on line gas analyzer including Fourier transform infrared spectrometry (FTIR). This technique exploits the phenomenon of molecular IR absorption to generate an accurate real-time measure of gas concentration in complex mixtures. An IR beam is passed through a gas sample in a cell. The various gas molecules in the path of the beam interact with the IR radiation by absorbing the light at molecule specific wavelengths. Each gas species has a specific fingerprint absorption spectrum related to the vibrational and rotational energy levels characteristic of the molecule. The absorption of the IR light is read by a camera detecting removal of materials associated with contaminants.

The sensor 21 may use QMS Quadrupole Mass Spectrometry. A mass spectrometer analyzes gasses by ionizing the atoms and molecules, separating the ions by mass/charge (m/e) ratios, and displaying a mass spectrum plot of the m/e ratio versus peak intensity. Specific mass peaks can be monitored for changes in the gasses coming from the supercritical cleaning chamber 16. There are other forms of Mass spectrometry including laser ionization (LIMS) that may be used as the sensor 21.

In accordance with another embodiment of the present invention the sensor 21 may be in the analyzer 17 as a laser particle counter, like that used to count particles in the air, is used to view the gasses leaving the chamber 16. As the particle counts change during the processing of a wafer, an end point can be determined based on a decrease in the total counts per second or based on the slope of the change in counts.

A reflectometer can be used as a sensor to bounce electromagnetic radiation off the surface of the wafer 15 that is in the process chamber 16. A trace is made of the changes in the reflected electromagnetic wave and an endpoint can be determined. The wavelength can be UV, IR, x-ray or visible light depending on nature of the contaminate to be cleaned.

The sensor 21 may use X-ray Fluorescence spectroscopy (XRF) that uses an x-ray beam to excite and fluorese x-rays from the wafer surface. The lack of presence of the contaminate materials signals the end of the cleaning.

Infrared Spectroscopy (IR) utilizes a polarized infrared beam in and internal reflection mode at the surface to absorb light according to chemical bond energies. Absorption energies provide chemical information about the native oxide and the internal reflection increases sensitivity to surface contamination. This may be used as the sensor 18.

Although specific embodiments of the present invention are herein described, they are not to be construed as limiting the scope of the invention. Many embodiments of the present invention will become apparent to those skilled in the art in light of the methodology of the specification. The scope of the invention is limited only by the claims appended.

1. A semiconductor device fabrication apparatus comprising: a supercritical fluid media cleaning chamber containing supercritical cleaning media and a semiconductor wafer for removing inorganic contamination from the wafer and
a detection sensor at the chamber or coupled to the effluent from the chamber that measures a property associated with the surface of semiconductor wafer to determine when the contamination removal is sufficiently complete or to verify that the process is within a normal process operation range.

2. The apparatus of claim 1 wherein the sensor monitors residual gas from the chamber.

3. The apparatus of claim 1 wherein the sensor is a laser based particle detector on the effluent gasses is used to determine when the process is complete or to verify that the process is within a normal process operation range.

4. The apparatus of claim 2 wherein said residual gas monitor determines what atomic mass units are in the effluent out of the chamber.

5. The apparatus of claim 4 wherein an indication that the wafer is cleaned by the high common mass units in the effluent drop down toward zero when the polymers are removed.

6. The apparatus of claim 1 wherein said sensor is a laser particle-counting device.

7. The apparatus of claim 1 wherein the sensor senses electrical or thermal conductivity.

8. The apparatus of claim 1 wherein the sensor measures properties related to the wafer processing such as the particle level, the amount of co-solvent in the supercritical fluid, the amount of residue in the fluid leaving the chamber, etc.

9. The apparatus of claim 1 wherein the sensor looks for when a particular peak in what atomic weight disappears.

10. The apparatus of claim 9 wherein said apparatus includes means for determining which etch chemistry is in use and which dielectric is being etched through and determining a species that has a characteristic atomic mass in it and said sensor looks for the peak of said characteristic mass to approach zero.

11. The apparatus of claim 1 wherein said sensor in a re-circulation system the residual gas analyzer looks for high molecular weights to decrease or going to zero.

12. The apparatus of claim 11 wherein those using electro solvents and those not using co-solvents look for rate of rise of the species detected approaching zero.

13. The apparatus of claim 1 wherein the sensor in the chamber 16 uses a property of the surface of the wafers using absorbance, reflection or deflection of ultraviolet, infrared, X-ray or visible light on the wafer surface and determines when it is cleaned or when the process step is complete.

14. The apparatus of claim 13 wherein the sensor includes sending a beam that hits the wafer and detects if the surface reflectance, absorbance or color has changed.

15. The apparatus of claim 1 wherein if doing bulk photoresist removal the detection by the sensor is optical and correlates using light measurement to detect when the reflectance changes whereby the reflectance of light on the wafer changes and detects when the photoresist is gone.

16. The apparatus of claim 1 wherein the sensor is a laser based gas particle detector on the effluent gas whereby the sensor projects light through the gas stream in the effluent and based on how the light is scattered, the size and quantity of particles in the gas stream is measured to determine when the cleaning process is complete.

17. The apparatus of claim 1 wherein the sensor is a reflectometer that bounces electromagnetic radiation off the surface of the wafer that is in the process chamber and a trace is made of the changes in the reflected electromagnetic wave.

18. The apparatus of claim 17 wherein the wavelength can be UV, IR, x-ray or visible light depending on nature of the contaminate to be cleaned.

19. The apparatus of claim 1 wherein the sensor uses X-ray Fluorescence spectroscopy (XRF) that uses an x-ray beam to excite the fluorescence x-rays from the wafer surface elements and the lack of presence of the contaminate materials signals the end of the cleaning.

20. A method of cleaning a semiconductor wafer comprising the steps of: removing inorganic contamination from a layer overlying a substrate using supercritical media in a supercritical cleaning chamber and sensing at the chamber or coupled to the effluent from the chamber a property associated with the surface of semiconductor wafer to determine when the contamination is sufficiently complete or to verify that the process is within a normal process operation range to control the cleaning process.

21. The method of claim 20 wherein said sensing monitors residual gas from the chamber.

22. The method of claim 21 wherein said residual gas monitor determines what atomic mass units are in the effluent out of the chamber.

23. The method of claim 22 wherein an indication that the wafer is cleaned by the high common mass units in the effluent drop down toward zero when the polymers are removed.

24. The method of claim 20 wherein the sensing includes a reflectometer that bounces electromagnetic radiation off the surface of the wafer that is in the process chamber and a trace is made of the changes in the reflected electromagnetic wave.

25. The method of claim 24 wherein the wavelength can be UV, IR, x-ray or visible light depending on nature of the contaminate to be cleaned.

26. The method of claim 20 wherein the sensing uses X-ray Fluorescence spectroscopy (XRF) that uses an x-ray beam to excite the fluorescence x-rays from the wafer surface elements and the lack of presence of the contaminate materials signals the end of the cleaning.

27. The method of claim 20 the sensing is a laser based gas particle detector on the effluent gas whereby the sensor projects light through the gas stream in the effluent and based on how the light is scattered, the size and quantity of particles in the gas stream is measured to determine when the cleaning process is complete.

28. The method of claim 20 wherein the sensing measures properties related to the wafer processing such as the particle level, the amount of co-solvent in the supercritical fluid, the amount of residue in the fluid leaving the chamber, etc.

29. The method of claim 20 wherein the sensing looks for when a particular peak in the atomic weight spectrum disappears.

30. The method of claim 29 said sensing includes determining which etch chemistry is in use and which dielectric is being etched and determining a species that has a characteristic atomic mass in it and said sensor looks for the peak of said characteristic mass to approach zero.

31. A method of cleaning a semiconductor wafer comprising the steps of:
plasma ashing to remove photoresist leaving a residual polymer composed of carbon, hydrogen, oxygen, and silicon as well as some of the low K dielectric as well as the etch gasses;
removing the above and inorganic contamination from a layer overlying a substrate using supercritical media in a supercritical cleaning chamber and sensing at the chamber or coupled to the effluent from the chamber a property associated with the surface of the semiconductor wafer to determine when the contamination removal is sufficiently complete or to verify that the process is within a normal process operation range to control the cleaning process.
